(19) United States
(12) Patent Application Publication
(10) Pub. No.: US 2011/0259203 A1
(43) Pub. Date: Oct. 27, 2011

(54) High Efficiency Multipath Heat Exchanger for Coffee Maker

(75) Inventor: Shawki Hamdi Mograbi, Plano, TX (US)

(73) Assignee: J. C. Penney Private Brands, Inc., Plano, TX (US)

(21) Appl. No.: 12/764,272

(22) Filed: Apr. 21, 2010

(51) Int. Cl. A47J 31/44; H05B 1/02; F24H 1/10

(52) U.S. Cl. 99/288; 392/481; 219/490

(57) ABSTRACT

A high efficiency coffee maker is disclosed. An exemplary high efficiency coffee maker includes a heating element; and a passageway operable to conduct a liquid therethrough. The passageway has at least two overlapping portions, each of the overlapping portions being in thermal contact with the heating element.

### BACKGROUND

Conventional coffee makers utilize a single tube heat exchanger system to heat water used for brewing coffee. These coffee makers typically include a single water tube and a heating element. Portions of the water tube are in contact with the heating element, and heat transfer can occur where the water tube and heating element are in contact. As water from a water reservoir is pushed through the water tube, heat is transferred from the heating element to water flowing through the water tube. It has been observed that area of heat transfer in the single tube heat exchanger system is substantially limited and inefficient. This results in substantial energy loss. Although such approaches to heating water have been generally adequate for their intended purposes, they have not been entirely satisfactory in all respects.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is a perspective view of an embodiment of a high efficiency coffee maker according to aspects of the present disclosure;

FIG. 2 is a perspective view of an embodiment of a heating assembly of the high-efficiency coffee maker of FIG. 1 according to aspects of the present disclosure;

FIG. 3 is a cross-sectional perspective view of an embodiment of the heating assembly of FIG. 2 according to aspects of the present disclosure;

FIG. 4 is a perspective view of the heating assembly of FIG. 2 that illustrates a liquid flow direction through the heating assembly according to aspects of the present disclosure.

### DETAILED DESCRIPTION

The present disclosure relates generally to a high efficiency coffee maker, and more particularly, to a heating assembly for a high-efficiency coffee maker.

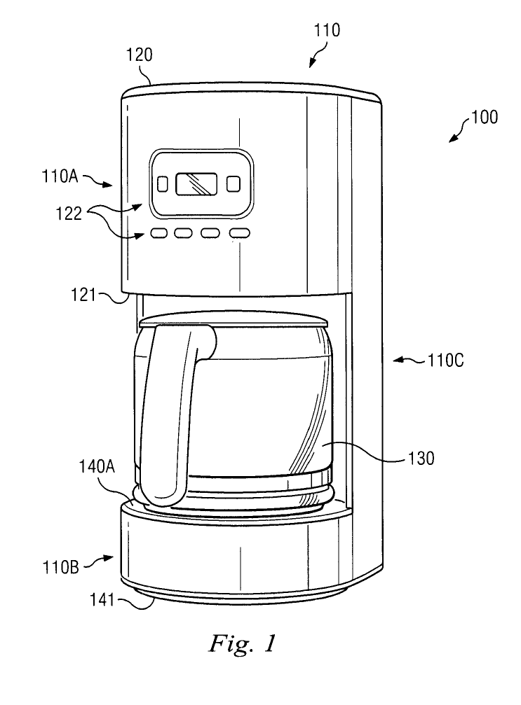

FIG. 1 is a perspective view of an embodiment of a high efficiency coffee maker 100 according to aspects of the present disclosure. The coffee maker 100 shown in FIG. 1 is a drip coffee maker as known in the art, and thus, some conventional features are not described in detail herein. It is understood that additional features can be added in the coffee maker 100, and some of the features described below can be replaced or eliminated, for additional embodiments of the coffee maker 100. Further, the present disclosure is applicable to other types of coffee brewing or tea brewing machines, now known or to be developed.

The coffee maker 100 includes a housing 110 that includes an upper housing portion 110A, a lower housing portion 110B, and a middle housing portion 110C that extends between and joins the upper and lower housing portions 110A, 110B. The upper housing portion 110A includes a top surface 120 and a bottom surface 121. A liquid reservoir and a brewing unit are housed within the upper housing portion 110A. In the present embodiment, the liquid reservoir is a water reservoir (not shown) and the brewing unit is a coffee brewing unit (not shown). The liquid reservoir may be another suitable water source, such as a water line. The upper housing portion 110A includes a removable cover that provides access to the liquid reservoir (not shown) and brewing materials, such as ground coffee, coffee filter packets, tea packets, coffee pods, and/or tea pods, in the brewing unit (for example, ground coffee can be provided in a ground coffee basket, which is a part of the brewing unit).

The upper housing portion 110A further includes a hot water outlet (not shown) and a cold water inlet (not shown). The cold water inlet and hot water outlet are in liquid communication via a passageway housed in the upper, lower, and middle housing portions 110A, 110B, 110C. The cold water inlet is coupled in liquid communication with the liquid in the liquid reservoir. The hot water outlet can be coupled to a fountain head that is generally disposed above the brewing unit and operable to release heated liquid into the brewing unit. The heated liquid passes through the brewing unit, particularly the brewing materials (e.g., ground coffee compartment), exits through a liquid opening/outlet at the bottom surface 121 of the upper housing portion 110A, and is captured and stored in a carafe 130 (described in further detail below).

A display/control panel 122 is included in the upper housing portion 110A. The display/control panel 122 may include a display, one or more indicator lights, and functional buttons. The display can be an LED digital display. The functional buttons can include an on/off (power) button, a program button, an hours button, a minutes button, an aroma button, an automatic setting button, other functional buttons, and combinations thereof. The display/control panel 122 is coupled to electrical components, which are housed in the upper housing portion 110A, lower housing portion 110B, and/or middle housing portion 110C. The electrical components can include one or more printed circuit boards (PCB) (or other suitable element) that facilitates electrical operations and electronic control of the coffee maker 100. For example, the electrical components can include clock and timer operations, such that a time is displayed on the display, the time being a time of day or a remaining brewing time.

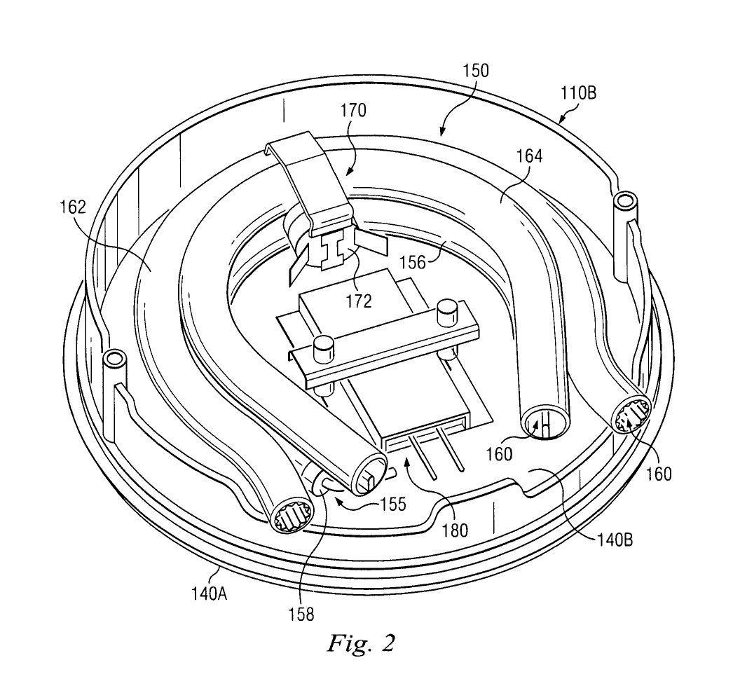

The lower housing portion 110B includes a top surface 140A and a bottom surface 141. The lower housing portion 110B includes a heating assembly 150 (FIG. 2). As will be discussed in detail below, the heating assembly 150 receives liquid at a first temperature from the liquid reservoir and delivers the liquid at an increased temperature to the brewing unit. The top surface 140A of lower housing portion 110B includes a base plate, which is a heater/warming plate for a carafe, such as carafe 130, and thus can maintain a warm temperature of any liquid, such as coffee, in the carafe 130. As illustrated, the carafe 130 is disposed in the housing 110, particularly, on the base plate in the lower housing portion 110B. The carafe 130 is positioned such that an opening (not shown) in the carafe 130 is located below the liquid opening/outlet (not shown) in the bottom surface 121 of the upper housing 110A. Thus, when liquid exits through the opening after passing through the brewing unit, it flows into the carafe 130. The opening can be alternatively referred to as a “water fountain.” In the present embodiment, the carafe 130 is a conventional glass carafe. Alternatively, the carafe 130 is another suitable carafe, including future developed carafes. As another alternative, the coffee maker 100 may not employ a carafe to store the brewed beverage, but instead, dispenses the beverage directly into a single-serve cup or another suitable container.

As noted above, the upper housing, lower housing, and middle housing portions 110A, 110B, and 110C include a passageway. The passageway is configured for liquid to flow therethrough. Specifically, a liquid flows through the passageway from the liquid reservoir in the upper housing portion 110A through the middle housing portion 110B to the heating assembly 150 in the lower housing portion 110B, and back to the brewing unit in the upper housing portion 110A. Multiple passageways can collectively form the passageway. Each passageway may be defined within a tube that is configured to conduct liquid. In the present embodiment, the passageway includes a portion of the heating assembly 150 in the lower housing portion 110B. The passageway can be defined by one or more tubes constructed of various materials, for example, conductive material, insulating material, and combinations thereof.

The passageway also includes a one-way check valve, which is configured to allow liquid flow in a specific direction only. For example, the one-way check valve allows cold liquids from the liquid reservoir to flow into the heating assembly and prevents hot liquids (heated by the heating assembly) to flow backwards into the cold liquid reservoir. The configuration of the passageway is not limited by the description herein, and it is understood that the passageway comprises any configuration and/or elements necessary to enable liquid to flow from the liquid reservoir to the brewing unit.

FIG. 2 is a perspective view of an embodiment of the heating assembly 150 of the high-efficiency coffee maker 100 of FIG. 1 according to aspects of the present disclosure. The lower housing portion 110B is shown inverted, such that the base plate and the top surface 140A is on the bottom. The bottom surface 141 of the lower housing portion 110B, and a heat insulating cover (not shown), is removed in FIG. 2 so that the heating assembly 150 in the lower housing portion 110B can be viewed. The heating assembly 150 is operable to efficiently increase the temperature of a liquid flowing therethrough. In the present embodiment, the heating assembly 150 includes a heating element unit 155 and a liquid heating passageway 160.

The heating element unit 155 includes a heating element housing 156 and a heating element 158. In the present embodiment, the heating element unit 155 is substantially U-shaped. Alternatively, other shapes and/or configurations are contemplated for the heating element unit 155, such as substantially V-shaped, L-shaped, elliptical-shaped, rectangular shaped, asymmetrically shaped, or other suitable shapes. The heating element housing 156 is coupled to lower housing portion 110B, such as a bottom surface 140B of the base plate (a surface of the base plate opposite the top surface 140A). The heating element housing 156 is a conductive tube, such as tube constructed of aluminum, aluminum composite, stainless steel, or another suitable material. The conductive heating element housing 156 can also include an insulating material therein that encases the heating element 158. Heat is generated when electricity flows through the heating element 158. The heating element 158 may be of a resistive type. An exemplary resistive heating element 158 is a wire coil. Other forms of suitable heating element 158 may be incorporated.

As noted above, the liquid heating passageway 160 can be considered a portion of the passageway that extends between the liquid reservoir and brewing unit. The liquid heating passageway 160 is defined within at least two conductive liquid tubes, such as conductive liquid tubes 162 and 164. In the present embodiment, the conductive liquid tubes 162, 164 mirror the general shape of the heating element unit 155, and thus, each conductive liquid tube 162, 164 is substantially U-shaped to mirror the configuration of the heating element unit 155. Alternatively, other shapes and/or configurations are contemplated for the conductive liquid tubes 162, 164, such as substantially V-shaped, L-shaped, elliptical-shaped, asymmetrically shaped, or other suitable shapes. The conductive liquid tubes 162, 164 may be of a singular construction or include two or more tubes in liquid communication with one another. The conductive liquid tubes 162, 164 comprise any suitable material, for example, aluminum, aluminum composite, stainless steel, or another suitable material.

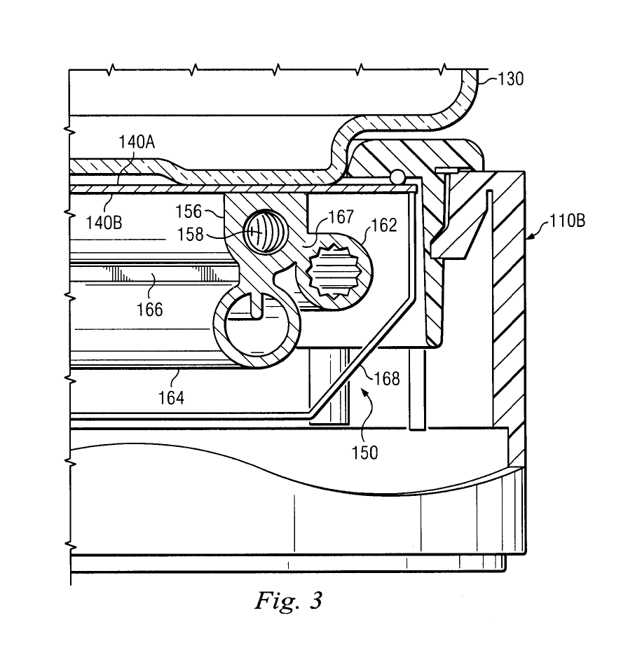

As illustrated in FIG. 2, the conductive liquid tubes 162, 164 overlap one another. The conductive liquid tubes 162, 164 are further in direct thermal contact with the heating element housing 156. As shown in FIG. 2, substantially the entire lengths of the conductive liquid tubes 162, 164 are in thermal contact with the heating element housing 156 to facilitate efficient heat transfer. This enables the liquid flowing through the conductive liquid tubes 162, 164 to be heated up very quickly. FIG. 3 is a cross-sectional perspective view of an embodiment of the heating assembly 150 of FIG. 2 according to aspects of the present disclosure. In FIG. 3, the orientation of the lower housing portion 110B is such that the top surface 140A (top surface of the base plate, heating/warmer plate) is oriented above the heating unit assembly.

In cross-section, the conductive liquid tubes 162, 164 may comprise any suitable configuration. For example, the conductive liquid tube 162 and/or conductive liquid tube 164 could include a circular cross-section, one or more longitudinal extensions, or include a flanged cross-section. Other cross-sections for the heating element housing 156 and conductive liquid tubes 162, 164 are contemplated by the present disclosure, such as triangular, elliptical, square, rectangular, and a combination of cross-sectional shapes. Further from this view, it is apparent that the conductive liquid tubes 162, 164 overlap one another. In the present embodiment, conducting material ribs 166, 167 couple the heating element housing 156 and the conductive liquid tubes 162, 164. More specifically, a conducting material rib 166 extends substantially along the entire length between the conductive liquid tube 162 and heating element housing 156, and another conducting material rib 167 extends substantially along the entire length between the conductive liquid tube 164 and heating element housing 156. Alternatively, conductive material ribs 166 and/or 167 may include one or more elongated conductive material ribs intermittently disposed between the conductive liquid tubes 162, 164 and heating element housing 156.

The conducting material ribs 166, 167 comprise a material, such as aluminum, aluminum composite, stainless steel, or another suitable material, that enables efficient energy transfer between the heating element unit 155 and the conductive liquid tubes 162, 164. Accordingly, heat generated by the heating element 158 efficiently transfers to the conductive liquid tubes 162, 164, and the liquid flowing through the conductive liquid tubes 162, 164. Due to the heat/energy transfer function of the heating assembly 150, it is alternatively referred to as a heat exchanger, and in the present embodiment, a double/multipath heat exchanger. It is understood that additional conductive liquid tubes can be included in the heating assembly 150, where each conductive liquid tube is in thermal contact with the heating element unit 155.

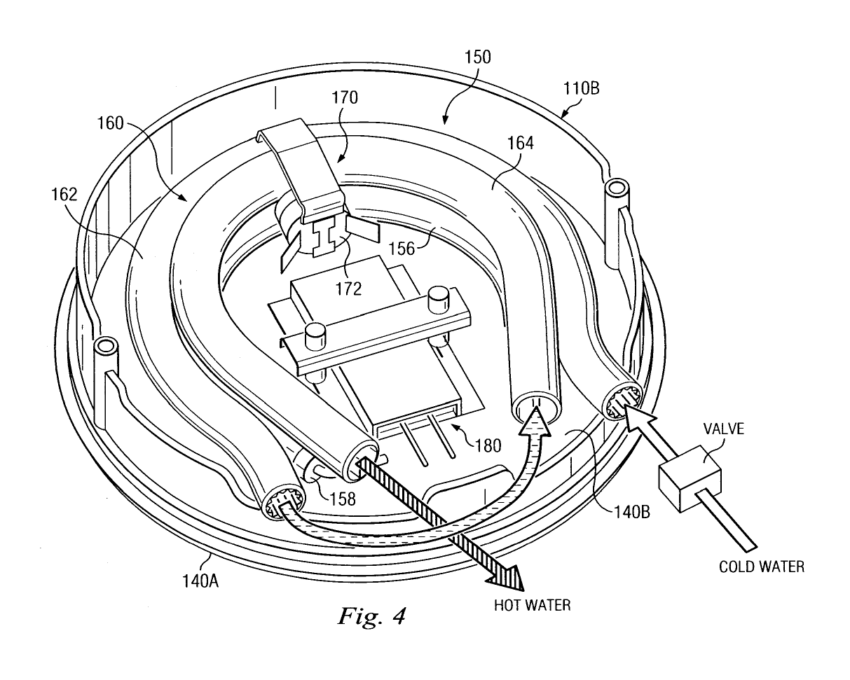

The conductive liquid tubes 162, 164 are in liquid communication with one another, such that liquid flows into and through the conductive liquid tube 162 and into and through the conductive liquid tube 164. This is illustrated in FIG. 4, which is identical to FIG. 2, except that a directional flow of liquid through the heating assembly 150 in lower housing portion 110B is illustrated. In this embodiment, the communicating conductive liquid tubes 162, 164 form the liquid heating passageway in a helical configuration, but other flow configurations are contemplated. More specifically, cold liquid flows in the lower housing portion 110B into one end of the conductive liquid tube 162. As the cold liquid flows through conductive liquid tube 162, it receives energy/heat from the conductive liquid tube 162 (which was received from the heating element unit 155). The heated liquid exits the conductive liquid tube 162 at another end and flows into an end of the conductive liquid tube 164. As the heated liquid flows through conductive liquid tube 164, it receives additional energy/heat (“super heat”) from the conductive liquid tube 164 (which was received from the heating element unit 155). It can be said that the heated liquid becomes super heated while flowing through the conductive liquid tube 164. The super heated liquid then exits the conductive liquid tube 164 at another end into the passageway that leads to the brewing unit in the upper housing portion 110A. In an example, the super heated liquid can achieve a temperature from about 185° C. to about 190° C. at the hot water outlet coupled to the fountain head, for example.

The heating assembly configuration of the coffee maker 100 provides improved efficiency and maximizes energy transfer. The improved efficiency in energy transfer can be achieved because the heating assembly configuration increases the exposure of the liquid in the liquid heating passageway 160 to the heating element unit 155. The increased liquid contact time facilitates increased energy/heat transfer from the heating element unit 155 to the liquid heating passageway 160, specifically to conductive liquid tubes 162, 164. This enables a lower wattage heating element to be used in the heating element unit 155. Because of the heating assembly configuration of the coffee maker 100, a heating element 158 having a rating of about 800 W to about 900 W, for example, is capable of heating the liquid to a temperature achieved by a 1,200 W heating element in a conventional coffee maker. The reduced power required for heating the liquid can provide substantially improved energy efficiency.

Referring again to FIG. 3, a heat insulating cover 168 encases the heating assembly 150, particularly the heating element housing 156, the heating element 158, conductive liquid tube 162, and conducive liquid tube 164. The heat insulating cover 168 can reduce or minimize energy escaping from the heat assembly environment, maintaining the liquid flowing through the heating assembly 150 at higher temperatures. The heat insulating cover 168 comprises one or more materials selected to contain heat within the heat assembly environment, and can be selected based on the material's energy transfer coefficient. In the present embodiment, the heat insulating cover 168 comprises an insulating material, such as silicone.

Conventional coffee makers sense liquid flowing through the heating assembly and cut off electrical power when most of the liquid from the liquid reservoir has flowed through a liquid tube of a heating assembly. Consequently, liquid remaining inside the liquid tube turns into steam at the end of the brewing cycle. In contrast, the disclosed coffee maker 100 shuts off the heating assembly based on the level of liquid within the liquid reservoir, as opposed to the liquid tubes associated with the heating assembly. This prevents the release of excessive steam in the brewing cycle. For example, referring again to FIG. 2, a clip 170 that includes a thermostat 172 extends around the heating element unit 155 (heating element housing 156 and heating element 158) and liquid heating passageway 160 (conductive liquid tubes 162, 164). The location of the clip 170 and thermostat 172 can vary. The thermostat 172 monitors the temperature of the heating element unit 155 (heating element housing 156 and heating element 158). The thermostat 172 can be configured in communication with a liquid sensor in the liquid reservoir in the upper housing portion 110A. The liquid sensor measures the level of liquid within the liquid reservoir by monitoring the location of a floater (e.g., a magnetic floater) within the liquid reservoir. The location of the floater is dependent on the amount of liquid remaining within the liquid reservoir. When the floater in the liquid reservoir reaches a predetermined level (in other words, indicating that the level of the liquid is below a certain level in the liquid reservoir), this information is relayed to the liquid sensor. In response, the liquid sensor communicates with various electrical components to implement cutoff of the heating element unit 155. For example, the liquid sensor can notify the electrical components (e.g., PCB) that the predetermined level has been reached (by generating a signal to the electrical components) that the heating element 158 should be shut off, and the heating element 158 is then shut off by the electrical components. This reduces/prevents steam during a brewing cycle.

Conventional coffee makers also utilize the same heating element that heats the brewing water to heat or warm the vessel storing the brewed coffee. In these coffee makers, when the temperature of the heating element rises to a first set temperature, such as 150° C., the heating element is shut off, and when the temperature of the heating element falls to a second set temperature, such as 130° C., the heating element is turned on again. Thus, the heating element is intermittently switched on and off to heat the brewed coffee inside the carafe. Since the heating element for these coffee makers typically ranges from about 900 W to 1300 W, significant energy is consumed.

Referring again to FIG. 2, the coffee maker 100 implements a separate low wattage plate heater assembly 180 in the lower housing portion 110B. The plate heater assembly 180 is coupled to the bottom surface 140B of the base plate 140. The base plate in the lower housing portion 110B can be considered a part of the plate heater assembly 180. The plate heater assembly 180 utilizes a heater having a self-temperature regulating characteristic. For example, in the present embodiment, the plate heater assembly 180 utilizes a positive temperature coefficient (PTC) heater, and thus will alternatively be referred to as PTC heater 180. The PTC heater 180 comprises ceramic stones, based on a barium titanate material, for example. The ceramic stones exhibit a self temperature limiting resistive characteristic. More specifically, the ceramic stones have a quick heating response time and plateau once a pre-defined reference temperature is reached. Above the reference temperature, the properties of the ceramic stones are utilized to produce a rise in resistance, and hence produce its self limiting properties. This resistance rise can be experienced over a temperature range of a few degrees Celsius. Thus, the PTC heater 180 can self-regulate at a pre-set temperature and automatically vary its wattage in order to maintain that pre-set temperature.

The PTC heater 180 is in communication with the liquid sensor and/or electrical components, such that it is notified when the liquid in the liquid reservoir is below a certain level, at which time, the PTC heater 180 is turned on. The PTC heater 180 then heats the base plate, such that the liquid in the carafe 130 can stay warm. When the PTC heater 180 is turned on, it can generate heat at a steady power and temperature, and can also generate even heating compensation. The PTC heater 180 is of a suitable wattage, such as about 50 W to about 60 W. The PTC heater 180 enables it to stay on, as opposed to intermittently shutting on and off, for a predetermined amount of time, such as two hours, without overheating the brewed coffee. Accordingly, the total energy consumption is much less compared to heating mechanisms used for the heating plates in conventional coffee makers. It is understood that in some embodiments, the heating element unit 155 (heating element housing 156 and heating element 158) can be used in conjunction with the PTC heater 180 to heat the base plate.

Below are tables that illustrate that the disclosed coffee maker exhibits increased efficiency over conventional coffee makers.

| | Coffee | | | | |
|---|---|---|---|---|---|
| | Maker 100 | Coffee | Coffee | Coffee | Coffee |
| | (880 W; | Maker | Maker | Maker | Maker |
| Comparison 1 | 52.5 W) | # 1 | # 2 | # 3 | # 4 |
| Brewing | 0.1648 | 0.1844 | 0.1831 | 0.1704 | 0.1612 |
| Warming | 0.1050 | 0.1417 | 0.1351 | 0.1475 | 0.1604 |
| Total Consumption | 0.2698 | 0.3261 | 0.3182 | 0.3179 | 0.3216 |
| (Brewing + | | | | | |
| Warming) | | | | | |

| | | | | |
|---|---|---|---|---|
| Energy Savings | 17.26% | 15.21% | 15.13% | 16.11% |

| | Coffee | | | | |
|---|---|---|---|---|---|
| | Maker 100 | Coffee | Coffee | Coffee | Coffee |
| | (850 W; | Maker | Maker | Maker | Maker |
| Comparison 2 | 60 W) | # 1 | # 2 | # 3 | # 4 |
| Brewing | 0.1465 | 0.1844 | 0.1831 | 0.1704 | 0.1612 |
| Warming | 0.1200 | 0.1417 | 0.1351 | 0.1475 | 0.1604 |
| Total Consumption | 0.2665 | 0.3261 | 0.3182 | 0.3179 | 0.3216 |
| (Brewing + | | | | | |
| Warming) | | | | | |

| | | | | |
|---|---|---|---|---|
| Energy Savings | 18.28% | 16.25% | 16.17% | 17.13% |

In Comparisons 1 and 2, the energy consumption of a coffee maker with the configuration disclosed herein, such as coffee maker 100, was compared to four different conventional coffee makers. Each of the conventional coffee makers utilize an approximately 1100 W heating element, with the heating element providing warming to the base plate. In Comparison 1, the coffee maker 100 includes a heating assembly 150 with wattage of approximately 880 W and a PTC heater having wattage of approximately 52.5 W; and in Comparison 2, the coffee maker 100 includes a heating assembly with wattage of approximately 850 W and a PTC heater having wattage of approximately 60 W.

For each coffee maker, the energy consumption (in kilowatts per hour) was observed for a brewing cycle and a warming cycle. For example, the brewing cycle was a brewing cycle that makes 12 cups of coffee, and the warming cycle is for 2 hours. The tables show the energy consumed in each cycle. The total energy consumption represents the total brewing energy consumption plus the total warming consumption. When comparing the total energy consumption of the coffee maker 100 to the total energy consumption of each of the conventional coffee makers, an energy savings (percentage) of the coffee maker 100 was determined and shown in the tables. From Comparisons 1 and 2, the coffee maker 100 provided at least a 15% energy savings over the brewing and warming cycles when compared to conventional coffee makers. It has also been observed that the disclosed coffee maker 100 can decrease brewing time. For example, the coffee maker 100 can complete a brew cycle for 1.2 cups of coffee in about 10 minutes to about 10:30 minutes, as opposed to 12 to 14 minutes exhibited by conventional coffee makers.

Referring to FIGS. 1-4, the operation of the coffee maker 100 will be described. In operation, the cold liquid in the liquid reservoir in the upper housing portion 110A flows from the cold outlet into the passageway. In the passageway, the cold liquid flows through the middle housing portion 110C to the lower housing portion 110B and into the heating assembly 150 via gravity. Because of the additional length in the passageway for the liquid to travel through (for example, because the liquid heating passageway 160 includes conductive liquid tubes 162 and 164), the liquid reservoir may be positioned at a greater height within the upper housing portion to improve the gravitational force and increase pressure of the liquid flowing to and through the heating assembly.

At some point along the passageway, the liquid flows through the one-way check valve (not shown), such that the liquid cannot flow back towards the liquid reservoir. As discussed above, when in the lower housing portion 110B, the cold liquid flows into one end (for example, an inlet) of the conductive liquid tube 162, where the liquid receives heat from the conductive liquid tube 162, which is heated by the heating element unit 155. The heated liquid exits the conductive liquid tube 162 at a second end, and flows into one end (for example, an inlet) of the conductive liquid tube 164, where the heated liquid receives additional heat from the conductive liquid tube 164, which is also heated by the heating element unit 155. The additionally heated liquid then exits the conductive liquid tube 145 at a second end into the passageway leading up to the upper housing portion 110A. The additionally heated liquid is typically boiling liquid, and thus, the boiling liquid within the passageway/conductive tubes 162, 164 is pushed through the passageway, from lower housing portion 110B to middle housing portion 110C to upper housing portion 110A, to the hot outlet (coupled to the fountain head) above the brewing unit in the upper housing portion 110A. The boiling liquid can be pushed through the passageway through an expansion physical property. The heated liquid then exits the passageway via the hot outlet port (fountain head) into the brewing unit. The heated liquid in the brewing unit flows through the brewing materials, and then exits the brewing unit via the liquid outlet and is collected in the carafe 130. Where, for example, additional conductive liquid tubes are provided in the heating assembly 150, the liquid would flow through each additional conductive liquid tube, receiving heat from each successive conductive liquid tube.

The foregoing disclosure provides many different embodiments, or examples, for implementing different features of the invention. Specific examples of components and arrangements are described above to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Spatially relative terms, such as “beneath,” “below,” “lower,” “above,” “upper” and the like, may be used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Further, the foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A high efficiency coffee maker comprising:
a heating element; and
a passageway operable to conduct a liquid therethrough, the passageway having a first portion overlapping a second portion, the first and second portions being in thermal contact with the heating element.

2. The high efficiency coffee maker of claim 1 wherein the first portion of the passageway is in liquid communication with a liquid reservoir and the second portion of the passageway is in liquid communication with a coffee brewing unit.

3. The high efficiency coffee maker of claim 2 wherein the first portion of the passageway is defined by a first conductive tube and the second portion of the passageway is defined by a second conductive tube coupled to the first conductive tube.

4. The high efficiency coffee maker of claim 1 wherein the passageway is in a generally helical configuration.

5. The high efficiency coffee maker of claim 1 wherein the heating element is substantially U-shaped.

6. The high efficiency coffee maker of claim 1 further comprising a heat insulating cover disposed over the heating element and the first and second portions of the passageway.

7. The high efficiency coffee maker of claim 2 further comprising a first elongated conductive rib coupled between the heating element and the first conductive tube and a second elongated conductive rib coupled between the heating element and the second conductive tube.

8. The high efficiency coffee maker of claim 1 wherein the heating element has a rating between about 800 Watts and 900 Watts.

9. A high efficiency brewer comprising:
an elongated heating element having a particular configuration;
a continuous liquid passageway having an overall configuration substantially mirroring the particular configuration of the elongated heating element, the continuous liquid passageway having a first and second overlapping elongated portions in direct thermal contact with the elongated heating element; and
wherein the elongated heating element is operable to efficiently transfer heat to a liquid flowing through the continuous liquid passageway a first time via the first elongated portion of the continuous liquid passageway, and a second time via the second elongated portion of the continuous liquid passageway.

10. The high efficiency brewer of claim 9 wherein the continuous liquid passageway is defined within a first conductive tube and a second conductive tube, the first and second conductive tubes each being in direct thermal contact with a substantial length of the elongated heating element.

11. The high efficiency brewer of claim 9 wherein the continuous liquid passageway comprises more than two overlapping elongated portions in direct thermal contact with the elongated heating element.

12. The high efficiency brewer of claim 9 further comprising:
a liquid reservoir in liquid communication with the continuous liquid passageway; and
a brewing unit in liquid communication with the continuous liquid passageway, the brewing unit for receiving the heated liquid.

13. The high efficiency brewer of claim 9 wherein the particular configuration of the elongated heating element is substantially U-shaped.

14. A high efficiency brewing apparatus comprising:
a liquid reservoir;
a brewing unit;
a continuous liquid passageway having at least two overlapping portions, the continuous liquid passageway being in liquid communication with the liquid reservoir and the brewing unit; and
a heating assembly that includes a heating element in thermal contact with the at least two overlapping portions of the continuous liquid passageway, the heating element being able to efficiently transfer heat to a liquid flowing through the at least two overlapping portions of the continuous liquid passageway.

15. The high efficiency brewing apparatus of claim 14 wherein the at least two overlapping portions of the continuous liquid passageway include a first conductive tube in liquid communication with a second conductive tube, the first and second conductive tubes being in thermal contact with the heating element, such that the liquid flows into and through the first conductive tube, where it receives heat from the heating element, and into and through the second conductive tube, where it receives additional heat from the heating element.

16. The high efficiency brewing apparatus of claim 14 wherein the heating assembly further includes a heat insulating cover disposed over the heating element and at least two overlapping portions of the continuous liquid passageway.

17. The high efficiency brewing apparatus of claim 14 further comprising a temperature sensing unit coupled to the heating assembly.

18. The high efficiency brewing apparatus of claim 14 further comprising a liquid sensing system operable to shut off the heating element of the heating assembly when an amount of liquid within the liquid reservoir falls below a particular level.

19. The high efficiency brewing apparatus of claim 14 wherein a portion of the heating assembly is coupled to a first surface base plate, the base plate having a second surface configured to receive a liquid storing vessel thereon.

20. The high efficiency brewing apparatus of claim 19 further comprising a base plate heating assembly coupled to the first surface of the base plate, the base plate heating assembly being operable to transfer heat to the base plate when the heating assembly is shut off.
